(19) United States
(12) Patent Application Publication
(10) Pub. No.: US 2006/0098668 A1
(43) Pub. Date: May 11, 2006

(54) Managing membership within a multicast group

(75) Inventor: Luigi De Dona, Bologna (IT)

Correspondence Address: CARR & FERRELL LLP, 2200 GENG ROAD, PALO ALTO, CA, 94303, US

(73) Assignee: TVBLOB S.r.l.

(21) Appl. No.: 11/266,126

(22) Filed: Nov. 2, 2005

Related U.S. Application Data
(63) Continuation-in-part of application No. 11/146,556, filed on Jun. 6, 2005.
(60) Provisional application No. 60/626,677, filed on Nov. 9, 2004.

(51) Int. Cl. H04L 12/56; H04L 12/28

(52) U.S. Cl. 370/401

(57) ABSTRACT

Each node on a network comprises an application level multicast module. An application level multicast module can determine efficient routing configurations for a host node's transmission and reception of multimedia data from the network. As two or more nodes receive and/or forward the same multimedia data, a multicast group is formed. A multicast group is two or more nodes that broadcast, receive, forward, and/or play the same multimedia data. Multiple nodes may join and leave the multicast group without significantly affecting the quality of a multicast. Since routing determinations are based on available resources by application level multicast modules at the node level within the multicast group, multiple nodes that join or leave the multicast group have little effect on the overall performance of the multicast group.

### CROSS-REFERENCE TO RELATED APPLICATIONS

This application is a continuation-in-part of U.S. Non-Provisional Patent Application No. 11/146,556 entitled “An Intelligent Application Level Multicast Module for Multimedia Transmission,” filed Jun. 6, 2005, which claims priority and benefit of U.S. Provisional Patent Application No. 60/626,677 entitled “Systems and Methods for Audio Video Communication,” filed Nov. 9, 2004, the disclosures of which are incorporated herein by reference.

### BACKGROUND

1. Field of the Invention

The present invention relates generally to the transmission of multimedia data. More particularly, the present invention relates to managing membership within a multicast group.

2. Background Art

As electronic communication and entertainment become more prevalent, multicasting is becoming ubiquitous. Multicasting is the concurrent distribution of multimedia data from one node to many nodes on a network. Multimedia data may be transmitted over the network to send videos, songs, sounds, animations, and images from one node to another. For example, multimedia data received by a node on the network may be a part of an event broadcast, a videoconference, a group collaboration, a presentation, a radio broadcast, a news broadcast, a sporting event, a broadcast, a podcast, a flash animation, an interactive game, a commercial, and/or an advertisement.

For the nodes on the network to consistently receive multimedia data at reasonable speeds, the nodes that receive multimedia data must be effectively managed. While new nodes on the network can request to receive multimedia data, other nodes may refuse to receive multimedia data or are turned off altogether. As these changes occur, the performance of the multicast system may suffer.

Multicasting has been implemented in several systems in the prior art, including Internet Protocol (IP) multicast, naïve-multicast, and multicast over a content delivery network. Although multicasting is becoming more common, the systems in the prior art are limited in that they are not scalable, adaptive, self-organizing, robust, or cost-effective.

IP multicast has been implemented at the network level in Internet routers. However, IP multicast was not designed for large scale use and thus IP multicast has limited router scalability and a rigid structure. IP multicast also has security problems. Further, there is often a need for administrative servers to intervene regarding network routing decisions. It is also expensive and time consuming to supply software updates to all the routers in the Internet.

Naïve-multicast is one of the most common systems on the Internet. It creates a unicast connection for each receiver. However, the system is not scalable. To manage 1000 receivers for a single 1 Mbs stream, a server-side connection of 1000 Mbs is necessary. It is often necessary to maintain a cluster of servers which can send the data to all receivers. As a result, the streaming video found on the Internet today is often of poor quality.

Multicast over a content delivery network is a system that is at the application level or the network level. Multicast over a content delivery network is a network of servers placed at strategic points on the Internet which allows distribution of data. However, the system is very expensive and is limited in the number of users that can be supported.

Although application level multicast module systems have been used to transmit multimedia data, the application level multicast module systems in the prior art have limited scalability. For example, application level multicast module systems in the prior art manage group membership through a central server which tracks every resource. The central server orders client positions within a spanning tree and manages every state for each node. As a result, the prior art lacks scalability and robustness. Further, this method suffers from slow response time.

### SUMMARY OF THE INVENTION

A system comprising a network interface configured to send routing information to and receive other routing information from a first node on a network, a distributed resource manager configured to send a routing message to and receive an other routing message from a second node on the network, a multimedia transmission router configured to send multimedia data to and receive multimedia data from a third node on the network, a transmission control layer module configured to process the multimedia data received from the multimedia transmission router and to ascertain a multimedia transmission quality metric, a host node manager configured to store host node information and to monitor host resource information, a quality manager configured to determine a multimedia metric limit based on the received multimedia transmission quality metric from the transmission control layer module, and a topology manager configured to determine a routing configuration and generate a routing control signal based on the routing configuration determination.

The first node may comprise the second node and/or the third node. Further, the first node on the network may comprise a child client, a parent server, a parent server/child client, or an administrative server.

The routing message may comprise an adoption request, an adoption acceptance acknowledgment, a leave request, and/or a redirection message. The routing configuration determination may be based on the host resource information received from the host node manager, the multimedia metric limit received from the quality manager, and/or the routing information received from the network interface. The routing information may comprise a node group identifier, a host node identifier, child node data, parent node data, and/or spare capacity group data.

The topology manager may be further configured to update a parent routing table and/or a children routing table. Moreover, the transmission control layer module may send the processed multimedia data to the multimedia player application.

A method comprising sending a leave request from a second node of a multicast group to a first node and at least one child node of the multicast group, updating a children routing table of the first node, updating the parent routing table of the second node, updating a children routing table of the second node, and updating the parent routing table of at least one child node of the multicast group.

A computer readable medium comprising computer readable code contained within the computer readable medium, the computer readable code configured to direct a processor to send a leave request from a second node of a multicast group to a first node and at least one child node of the multicast group, update a children routing table of the first node, update a parent routing table of the second node, update a children routing table of the second node, and update a parent routing table of at least one child node of the multicast group.

### BRIEF DESCRIPTION OF THE DRAWINGS

FIG. 1 illustrates a network for multimedia data transmission, in accordance with one embodiment;

FIG. 2 illustrates an exemplary multicast group 200 for multimedia data transmission;

FIG. 3 illustrates a block diagram of an application level multicast module, in accordance with one embodiment;

FIG. 4 is a flowchart depicting a method for the application level multicast module as may be used for a node leaving a multicast group, in accordance with one embodiment;

FIG. 5 is a flowchart depicting a method for the application level multicast module as may be used for a node joining a multicast group, in accordance with one embodiment; and

FIG. 6 illustrates a block diagram of a digital device that may implement the application level multicast module, in accordance with one embodiment.

### DETAILED DESCRIPTION OF THE EMBODIMENTS

Each node on a network may host an application level multicast module. The hosted application level multicast module can determine efficient routing configurations for the host node's transmission and reception of multimedia data across the network. Further, the application level multicast module may aggregate, buffer, process, and send multimedia data to and from an application such as a multimedia player application.

The application level multicast module can base routing configuration determinations on one or more factors. For example, the application level multicast module may base one or more of the routing configuration determinations on the quality of a multimedia data transmission, the performance of the host node, and/or the quality of the performance by other nodes receiving or forwarding multimedia data to the host node.

Routing configuration determinations by the application level multicast module allow individual nodes to track available resources. As a result, each individual node can make independent determinations regarding the forwarding and/or reception of multimedia data based on available resources.

As two or more nodes receive and/or forward the same multimedia data, a multicast group is formed. A multicast group is two or more nodes that broadcast, receive, forward, and/or play the same multimedia data. A node that broadcasts, receives, forwards, and/or plays multimedia data from the multicast group is a member of that multicast group.

A new node may become a member of a multicast group by being adopted by a node within the multicast group. A node may also leave the multicast group by refusing to receive multimedia data.

A node may leave a multicast group in at least three ways. First, the leaving node may simply refuse to receive multimedia data. Second, the leaving node may indicate the desire to leave the multicast group and then wait a predetermined period of time before refusing to receive multimedia data. Third, if the leaving node is receiving multimedia data from a sending node and forwarding multimedia data to a receiving node, then the leaving node can request that the sending node send multimedia data to the receiving node before the leaving node refuses to receive or forward multimedia data. There may be many methods a node may join or leave a multicast group.

As the number of nodes within a multicast group grows, each individual node determines if there are sufficient resources within that node to adopt another node. As a result, no centralized server is required and the system can scale based on available resources and performance requirements while maintaining control of the quality of service.

Multiple nodes may simultaneously join and leave the multicast group without significantly affecting the quality of service. Since the determinations are based on available resources at the node level within the multicast group, multiple nodes that join or leave may have little effect on the overall multicast group.

The application level multicast module is “intelligent” in that it can determine routing configurations without requiring an separate server on the network. The application level multicast module is “application level” since the application level multicast module operates at the seventh layer of the open systems interconnection model (Harry Newton, Newton's Telecom Dictionary 603-604 (20^{th} ed., CMP Books 2004)).

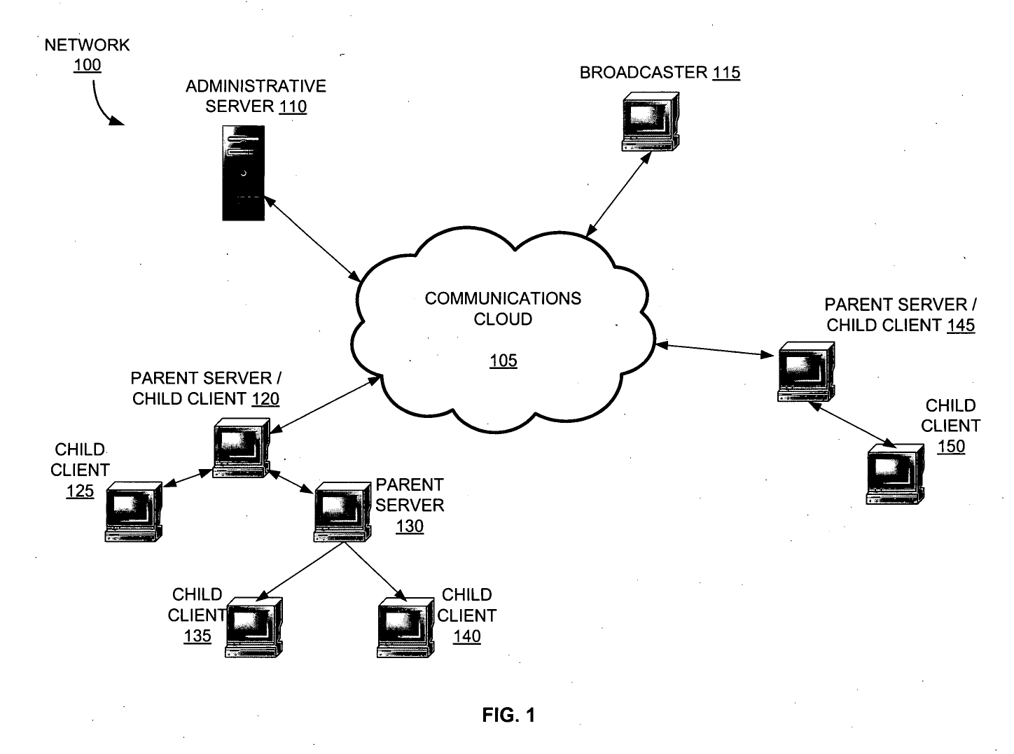

FIG. 1 illustrates a network 100 for multimedia data transmission, in accordance with one embodiment. A node is a digital device that communicates with other nodes on a network. In the network 100, nodes coupled to a communications cloud 105 include an administrative server 110, a broadcaster 115, a parent server/child client 120, a parent server/child client 145, a parent server 130, a child client 125, a child client 135, a child client 140, and a child client 150.

The communications cloud 105 couples the nodes together to allow the nodes to communicate and transmit multimedia data to each other. The communications cloud 105 may be a single device or multiple devices. In one embodiment, the communications cloud 105 is a router that routes multimedia data to a limited number of nodes. In another embodiment, the communications cloud 105 comprises multiple routers, bridges, and hubs that couple a large number of nodes. The communications cloud 105 may also be another network, such as the Internet, that allows nodes to communicate and transmit multimedia data to each other.

Depending upon the topology of the network 100, the communications cloud 105 is optional. For example, the network 100 may connect the nodes with a ring topology. In a ring topology, each node may communicate directly to one or two other nodes on the network 100 without the requirement of the communications cloud 105.

The broadcaster 115, the parent server/child client 120, the parent server/child client 145, the parent server 130, the child client 125, the child client 135, the child client 140, and the child client 150 can each comprise an application level multicast module. As such, each node on the network 100 can broadcast, receive, forward, play, and/or access multimedia data.

A broadcaster broadcasts multimedia data to one or more nodes on a network. For example, the broadcaster 115 can comprise a node with an application configured to allow a user of the broadcaster 115 to create original content, broadcast live multimedia data, or broadcast recorded content to the other nodes on the network 100.

A parent server is a node that receives and forwards multimedia data to one or more other nodes on a network. For example, the parent server 130 can receive multimedia data from the parent server/child client 120 and can forward multimedia data to the child client 135 and the child client 140. A parent server does not, however, play multimedia data.

Child clients are nodes that receive and play multimedia data from a network. For example, the child client 125, the child client 135, the child client 140, and the child client 150 can receive and play multimedia data from the broadcaster 115 on the network 100. In a further example, the child client 125 can buffer, process, and play multimedia data from the broadcaster 115 with the multimedia player application.

Child clients do not forward or broadcast multimedia data. However, child clients can transmit routing information to other nodes on a network. For example, the child client 125, the child client 135, the child client 140, and the child client 150 do not broadcast or forward multimedia data to any node on the network 100. However, the child client 125, the child client 135, the child client 140, and/or the child client 150 can transmit routing information to each other or any other node on the network 100.

Parent server/child client nodes receive, forward, and play multimedia data from a network. In an example, the parent server/child client 120 and the parent server/child client 145 can receive multimedia data from the broadcaster 115, forward multimedia data to another node on the network 100, and play multimedia data. Similar to child clients, the parent server/child client can buffer, process, and play multimedia data with the multimedia player application. The parent server/child client 120 and parent server/child client 145 can forward and play multimedia data simultaneously.

An administrative server is an optional node that may collect information regarding a network, the nodes, and/or the network routing. An example of the information regarding the network 100 may include throughput of data, efficiency of transmissions, transmission errors, data collision, lost packets, performance of individual nodes, and performance of groups of nodes. The broadcaster 115, the parent server/child client 120, the parent server/child client 145, the parent server 130, the child client 125, the child client 135, the child client 140, and the child client 150 can send information to the administrative server 110 regarding the quality of the multimedia data transmission, host performance, the performance of surrounding nodes, subscription memberships, authorization requests, and/or accounting information. An administrative server can optionally direct the nodes to conform to routing configurations.

The network 100 is a network capable of supporting multimedia data transmission. The network 100 may comprise a local area network (LAN), a wide area network (WAN), Internet, intranet, extranet, Internet Protocol (IP) network, or any other network. The network 100 may be a smaller portion of a larger network.

In another embodiment, the network 100 may comprise an overlay network. An overlay network is a virtual topology constructed on top of a network infrastructure. The concept of overlay networks enables multicast to be deployed as a service network rather than a network primitive mechanism, allowing deployment over heterogeneous networks without the need of universal network support. An overlay network known in the art is Pastry which is a network substrate that provides commands and services to nodes on a peer-to-peer network.

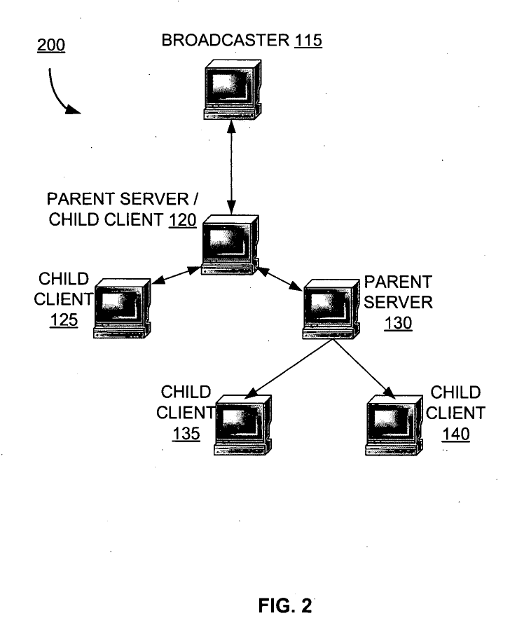

FIG. 2 illustrates an exemplary multicast group 200 for multimedia data transmission. The multicast group 200 comprises the broadcaster 115, the parent server/child client 120, the parent server 130, the child client 125, the child client 135, and the child client 140.

The broadcaster 115 broadcasts multimedia data to the parent server/child client 120 which both receives multimedia data from and forwards multimedia data to the child client 125 and the parent server 130. The parent server 130 receives multimedia data from the parent server/child client 120 and forwards multimedia data to the child client 135 and the child client 140. The child client 125, child client 135, and child client 140 each receive and play multimedia data with respective multimedia player applications.

The multicast group 200 may comprise one or more spare capacity groups and/or one or more spanning trees. A spare capacity group comprises one or more nodes, which may or may not be within a multicast group, that can permanently or temporarily receive and forward multimedia data to other nodes. For example, a node that is not a member of a multicast group but is a member of a spare capacity group can receive and forward multimedia data to another node within a multicast group. In another example, a node that is a member of a first multicast group as well as a spare capacity group can receive and forward multimedia data to another node within a second multicast group and/or a third node within a third multicast group. In yet another example, a node that is a member of a multicast group and a spare capacity group can receive and forward multimedia data to any other node within the same multicast group.

In another example, the parent server/child client 145 (FIG. 1) is not a member of the multicast group 200. However, the parent server/child client 145 may be a member of a spare capacity group and forward at least some multimedia data from the broadcaster 115 to one of the nodes of the multicast group 200. As a member of the spare capacity group, the parent server/child client 145 can permanently or temporarily forward at least some multimedia data to the nodes of the multicast group 200. In another example, the parent server/child client 145 is a member of a spare capacity group that forwards at least some multimedia data when performance within the multicast group 200 falls below a predetermined metric. In this example, the administrative server 110 monitors performance of the multicast group 200. When performance falls below the predetermined metric, the administrative server 110 orders the parent server/child client 145 within the spare capacity group to send multimedia data to one or more of the nodes of the multicast group 200.

The network 100 (FIG. 1) may comprise one or more spanning trees. In one example, spanning trees provide path redundancy while preventing undesirable loops in a network that may be created by multiple active paths between nodes. Loops occur when there are alternate routes between nodes. To establish path redundancy, a spanning tree spans all of the switches in a network or sub-network thereby forcing redundant paths into a standby, or blocked, state. Spanning trees allow one active path at a time between any two nodes, thus preventing loops, but establishes the redundant links as a backup if the initial link should fail. A spanning tree may comprise one or more spare capacity groups and/or one or more multicast groups.

For example, one spanning tree may include all of the nodes that are members of a single multicast group. Another spanning tree within the same network may include all of the nodes of a spare capacity group. A spanning tree may be the same size as the network or smaller. Each multicast group in a network comprises a new spanning tree within the network.

In one example, the multicast group 200 (FIG. 2), which comprises a smaller number of nodes than the network 100 (FIG. 1), is a spanning tree. The broadcaster 115 may also broadcast other multimedia data to the parent server/child client 145 and the child client 150 which would comprise a second multicast group 200 and a second spanning tree within the network 100. In this example, the broadcaster 115 is the root of the spanning tree. The parent server/child client 120, the parent server/child client 145, and the parent server 130 are branches within the spanning tree. The child client 125, the child client 135, the child client 140, and the child client 150 are leaves within the spanning tree.

The application level multicast module determines the routing configuration for each node within a spanning tree. The application level multicast module within each node will individually determine each node's routing configuration. For example, the user of the child client 140 may direct the application level multicast module to receive multimedia data from the broadcaster 115. Based on the available routing information (discussed further herein), the application level multicast module may generate a control signal to request the nearest parent server 130 or parent server/child client 120 to forward multimedia data.

An example of the implementation of an overlay network with an application level multicast module for the transmission of multimedia data is a channel based broadcast subscribe system. The channel based broadcast subscribe system is a distributed system working over an IP network which allows the management of services (e.g. multimedia data transmission and routing). The channel based broadcast subscribe system allows a user to subscribe to a particular channel on an IP network to receive a multimedia program or event.

A channel is a physical and/or logical transmission path for multimedia data. For example, in order for the child client 125 to receive multimedia data broadcast from the broadcaster 115, the child client 125 subscribes to the channel. Once the subscription has been authenticated and accepted, the child client 125 becomes a member of a multicast group and may receive multimedia data.

The administrative server 110 within the channel based broadcast subscribe system optionally authenticates subscription requests from the nodes, collects accounting information, and directs the nodes to conform to routing configurations based on subscription requests. The administrative server 110 may be a ticket server which manages the purchasing and accounting of subscription requests.

In one example, the child client 125 subscribes to the channel by sending a subscription request to the administrative server 110. Once the subscription request is authenticated and accepted by the administrative server 110, the administrative server 110 sends the child client 125 a ticket. In another embodiment, the child client 125 subscribes to the channel by sending a subscription request to an other node who is a member of the desired multicast group. Once the subscription request is authenticated and accepted by the other node, the other node sends the child client 125 a ticket.

A ticket is a verification that the child client 125 is authenticated and accepted into the channel. The application level multicast module of the child client 125 sends an adoption request with the ticket to the parent server/child client 120 which verifies the ticket and determines if the child client 125 will be adopted by the parent server/child client 120. If the parent server/child client 120 adopts the child client 125, the parent server/child client 120 forwards multimedia data to the child client 125. If the child client 125 is not adopted, the application level multicast module of the child client 125 sends the adoption request and the ticket to another node on the network 100.

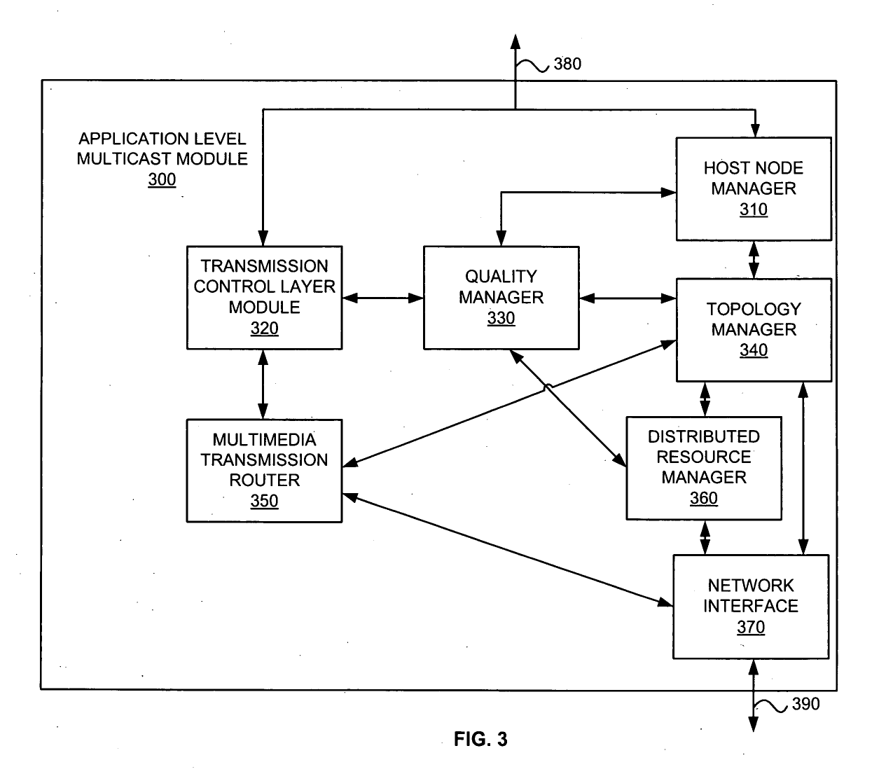

FIG. 3 illustrates a block diagram of an application level multicast module 300, in accordance with one embodiment. A host node (not depicted) may comprise the application level multicast module 300. The application level multicast module 300 comprises a host node manager 310, a transmission control layer module 320, a quality manager 330, a topology manager 340, a multimedia transmission router 350, a distributed resource manager 360, and a network interface 370. The application level multicast module 300 is coupled to an application link 380 and a network link 390 (discussed further herein).

The host node manager 310 is coupled to the quality manager 330, the topology manager 340, and the application link 380. The host node manager 310 collects and stores host resource information of the host node. The host resource information comprises available bandwidth, available memory, CPU performance, user settings, shared host node resources, host node identifier, node group identifier, dependability level, and/or spare capacity group level.

The available bandwidth of the host node is the measure of the capacity of data that can be moved at one time from the host node to another node on a network. In another embodiment, the available bandwidth is the measure of the capacity of data that can be received or both received and transmitted at one time by the host node.

The available memory includes both the memory and the storage system (further discussed herein) of the host node available. The CPU performance is an average performance of the host node over time. The CPU performance may comprise the quality of the processor (further discussed herein), available memory, multimedia application speed, quality of the transmission of multimedia data received by the host node, quality of the transmission of multimedia data forwarded by the host node, and speed at which multimedia data may be forwarded, buffered, or processed.

The user settings may be input by a user of the host node through a graphical user interface (GUI) (not depicted) or another application program that couples to the application level multicast module 300. The user settings may comprise the multicast group membership of the host node as well as the dependability level, and/or the spare capacity group level. Further, the user settings may comprise the bandwidth, memory, and/or available shared host resources allocated to the application level multicast module 300 by the user of the host node.

The shared node resources are those resources of the host node that may be shared with other nodes on the network. For example, if the host node is forwarding multimedia data to another node on the network, the shared node resources would comprise that portion of the host node's bandwidth, memory, and CPU performance that are allocated to the task.

The host node identifier identifies the host node. The host node identifier may be unique and used to identify the host node on the network. The host node identifier may comprise letters, numbers, or a combination of letters and numbers. In some embodiments, the user of the host node, the host node manager 310, the topology manager 340, or an administrative server assigns the host node identifier to the host node.

The node group identifier identifies the host node as a member of one or more multicast groups. For example, a user subscribes to a multicast group to receive a particular multimedia data transmission. The host node manager 310 may either receive or generate the node group identifier of the subscribed multicast group. The host resource information of the host node may further comprise multiple node group identifiers. For example, a separate node group identifier may be received or generated by the host node manager 310 for each multicast group of which the host node is a member.

The dependability level is a value that indicates the performance of the host node on the network over time. In one embodiment, a high dependability level indicates that the host node's performance is very consistent. For example, a dependability level of “0” is the lowest level available. The dependability level of “0” may indicate that the host node is frequently shut down. The dependability level of “4” may indicate that the host node is operating as a broadcaster. Further, the dependability level of “3” may indicate that the host node is operating at a high performance for a long period of time.

The dependability level may be assigned by the user of the host node or an administrative server. Further, the dependability level may be determined by the topology manager 340, the distributed resource manager 360, or both based upon available host resources, the availability of shared node resources, and/or multimedia transmission quality metrics.

The spare capacity group level is a value that indicates the ability of the host node to allocate shared node resources to receive and forward multimedia data to other nodes on the network. For example, a spare capacity group level of “0” is the lowest level available and designates the host node as capable of sharing with other nodes of dependability level “0”. A spare capacity group level of “1” may indicate that the host node can share bandwidth resources with the nodes of dependability level “1” and “0”. A spare capacity group level of “2” may designate the host node can share with nodes of dependability level “2”, “1”, and “0”. Further, a spare capacity group level of “3” may designate the host node can share with nodes of dependability level “3”, “2”, “1”, and “0”.

The spare capacity group level may be assigned by the user of the host node or the administrative server. Further, the spare capacity group level may be determined by the topology manager 340, the distributed resource manager 360, or both based upon the available host resources, the availability of shared node resources, and/or multimedia transmission quality metrics.

The transmission control layer module 320 is coupled to the quality manager 330, the multimedia transmission router 350, and the application link 380. The transmission control layer module 320 aggregates, buffers, and/or processes multimedia data received from the multimedia transmission router 350. The transmission control layer module 320 may send multimedia data to the application link 380. The application link 380 is any interface or path coupled to the multimedia player application, a multimedia broadcast application, or any application that controls, manipulates, edits, and/or plays multimedia data. The transmission control layer module 320 also ascertains a multimedia transmission quality metric and sends the multimedia transmission quality metric to the quality manager 330.

The multimedia transmission quality metric is a measurement of the transmission of multimedia data received by the host node. The multimedia transmission quality metric may comprise a response time metric, a packet loss metric, a packet delay metric, and/or a node stress metric. The response time metric is the time taken to receive an initial packet of data. The packet loss metric is the number of packets of data lost during a given period of time. The packet delay metric is the average time between packets of data. The node stress metric is determined by measuring the quantity and the distribution of the nodes receiving multimedia data from the host node. The multimedia transmission quality metric may comprise any number of measurements that collect information regarding multimedia data transmission, communications, or routing.

In another embodiment, the transmission control layer module 320 aggregates, buffers, and/or processes multimedia data received from an application over the application link 380. The transmission control layer module 320 can send multimedia data to the multimedia transmission router 350 to transmit multimedia data through network interface 370 and across network link 390 to one or more other nodes on the network.

The quality manager 330 is coupled to the host node manager 310, the transmission control layer module 320, the topology manager 340, and the distributed resource manager 360. The quality manager 330 monitors the quality of multimedia data transmission, evaluates performance of the host node, and recommends actions to the topology manager 340.

In one embodiment, the quality manager 330 receives and evaluates the multimedia transmission quality metric from the transmission control layer module 320 to determine a multimedia metric limit. The multimedia metric limit is an evaluation of the quality of the multimedia data transmission based on the multimedia transmission quality metric. The quality manager 330 then makes recommendations based on the multimedia metric limit and sends the recommendations to the topology manager 340. In another example, the quality manager 330 may send the multimedia metric limit to the topology manager 340 or send a multimedia data request to the distributed resource manager 360.

For example, the quality manager 330 may receive the multimedia transmission quality metric from the transmission control layer module 320. The quality manager 330 analyzes the multimedia transmission quality metric to determine the multimedia metric limit. The quality manager 330 may then make a recommendation and send the recommendation to the topology manager 340.

In another example, the number of packets of data lost (packet loss) during reception of a multimedia data transmission within a given time may be sent from the transmission control layer module 320 to the quality manager 330 as the multimedia transmission quality metric. The quality manager 330 receives the multimedia transmission quality metric and determines a multimedia metric limit that indicates that the packet loss is too high. The quality manager 330 may form a recommendation that the host node should receive the multimedia data transmission from another node on the network. The quality manager 330 can send the recommendation to the topology manager 340.

In another embodiment, the quality manager 330 evaluates performance of the host node. The quality manager 330 may receive and evaluate host resource information from the host node manager 310. The host resource information may indicate the performance of the host node. The quality manager 330 may then make and send recommendations to the topology manager 340. For example, the quality manager 330 receives the host resource information from the host node manager 310. Based on the host resource information, the quality manager 330 determines that the available resources of the host node are too low. The quality manager 330 can send a recommendation to the topology manager 340 that the host node should not forward multimedia data transmissions to other nodes on the network.

The quality manager 330 can also send the multimedia data request to the distributed resource manager 360. In one example, the quality manager 330 determines that multimedia data is needed from other nodes within the group. The quality manager 330 can send the multimedia data request to the distributed resource manager 360 requesting multimedia data from other nodes within the group. The distributed resource manager 360 may send the multimedia data request to the distributed resource manager 360 of one or more nodes within the group. In another example, the distributed resource manager 360 of the host node may receive a multimedia data request from a quality manager 330 of another node on the network. The distributed resource manager 360 can send a command for the requested multimedia data to the quality manager 330 of the host node. The quality manager 330 of the host node can receive the multimedia data request from the distributed resource manager 360 and then send a command for the requested multimedia data to the transmission control layer module 320. Subsequently, the transmission control layer module 320 can send a multimedia data request to the multimedia transmission router 350. The multimedia transmission router 350 can send the requested multimedia data to the requesting node. In another example, the quality manager 330 of the host node may receive the multimedia data request from the other node on the network.

The topology manager 340 is coupled to the host node manager 310, the quality manager 330, the multimedia transmission router 350, the distributed resource manager 360, and the network interface 370. The topology manager 340 manages the application level multicast module 300. In some embodiments, the topology manager 340 is not directly coupled to the network interface 370.

The topology manager 340 receives and stores child node data, parent node data, and spare capacity group data. The child node data is the information associated with the nodes that receive the forwarded multimedia data from the application layer multicast module 300. The child node data may be stored within a children routing table. The parent node data is the information associated with the nodes that transmit and/or broadcast multimedia data to the application layer multicast module 300. The parent node data may be stored within a parent routing table. The spare capacity group data is the routing information associated with the nodes that are members of a spare capacity group available to the application layer multicast module 300.

The topology manager 340 may receive the child node data, the parent node data, and the spare capacity group data from one or more nodes on the network or an administrative server. Further, the topology manager 340 may generate the child node data, the parent node data, and the spare capacity group data based on the routing information (discussed further herein) received from the distributed resource manager 360 and/or the network interface 370.

The topology manager 340 may receive the host resource information from the host node manager 310, the multimedia metric limit from the quality manager 330, and routing information from the network interface 370. The topology manager 340 may determine a routing characteristic based on the host resource information, the multimedia metric limit, or the routing information. The topology manager 340 can determine a routing configuration based on the routing characteristic. The topology manager 340 then generates a control signal based on the routing characteristic. The control signal may be sent from the topology manager 340, through the network interface 370, to an other node on the network 100 (FIG. 1) to request adoption, accept the adoption of the other node, or leave a multicast group. The process of determining a routing characteristic is described in further detail in pending U.S. application Ser. No. 11/146,556 entitled “An Intelligent Application level Multicast Module for Multimedia Transmission,” filed on Jun. 6, 2005, which is hereby incorporated herein by reference.

In one example, the topology manager 340 receives host resource information from the host node manager 310 indicating that the available bandwidth is very limited. The child node data indicates that the host node is forwarding multimedia data to a first node and a second node on an overlay network. Based on this information, the topology manager 340 determines a routing characteristic that indicates that multimedia data will be forwarded only to the first node. The routing configuration is determined based on the routing characteristic. In this example, the routing configuration is a determination that multimedia data is to be forwarded only to the first node. In some embodiments, the routing configuration is the routing characteristic. The process of determining a routing configuration is described in further detail in pending U.S. application Ser. No. 11/146,556 entitled “An Intelligent Application level Multicast Module for Multimedia Transmission,” filed on Jun. 6, 2005, which is hereby incorporated herein by reference.

The topology manager 340 then generates the control signal based on the routing configuration and transmits the control signal to the network interface 370. The network interface 370 receives the control signal and transmits commands through the overlay network to notify the second node that it will no longer be receiving multimedia data from the host node. The topology manager 340 will then notify the multimedia transmission router 350 to forward multimedia data to only the first node. Note that in other embodiments, the distributed resource manager 360 receives the control signal from the topology manager 340 and generates commands for the overlay network. In an example, the topology manager 340 may send requests for multimedia data or adoption requests to the distributed resource manager 360. The distributed resource manager 360 then sends the requests for multimedia data or adoption requests to the distributed resource manager 360 of other nodes.

The multimedia transmission router 350 is coupled to the transmission control layer module 320, the topology manager 340, and the network interface 370. In one embodiment, the multimedia transmission router 350 receives multimedia data from one or more other nodes on the network through the network interface 370. The multimedia transmission router 350 may forward multimedia data to one or more nodes on the network identified by the topology manager 340. The multimedia transmission router 350 may also send or receive multimedia data to the transmission control layer module 320. In another embodiment, the multimedia transmission router 350 receives multimedia data from the transmission control layer module 320. The multimedia transmission router 350 can transmit multimedia data to one or more other nodes on the network identified by the topology manager 340.

The network interface 370 is coupled to the topology manager 340, the multimedia transmission router 350, the distributed resource manager 360, and the network link 390. The network interface 370 is any network interface configured to transfer data between the application level multicast module 300 and any communications network over the network link 390. The network interface 370 is also any network interface configured to transfer data received from any communications network to the host node. The network link 390 is any logical or physical path coupled to a node or network.

The distributed resource manager 360 is coupled to the quality manager 330, the topology manger 340, and the network interface 370. The distributed resource manager 360 is configured to monitor resources of the node (further discussed herein), share resources of the node, and to request shared resources from other nodes.

The distributed resource manager 360 of a first node may form a group to share resources with one or more other nodes. In one example, the distributed resource manager 360 monitors resources of the first node and subsequently joins or subscribes to a spare capacity group in order to share resources or forward multimedia data to other nodes who are members of the spare capacity group. A distributed resource manager 360 or a topology manager 340 of a node receiving the subscription request from the first node can accept or refuse the subscription request.

In another example, the distributed resource manager 360 monitors resources of the host node and determines a spare capacity group level. The distributed resource manager 360 can subscribe to one or more spare capacity groups and transmit the host node's spare capacity group level. As a result, the distributed resource manager 360 can forward or receive multimedia data requests and/or routing information with other nodes of the same spare capacity group. In one example, the distributed resource manager 360 can send multimedia data requests and/or routing information to another node of a spare capacity group with the same spare capacity group level of the local host node. In other examples, the distributed resource manager 360 can subscribe to a spare capacity group with the same or lower spare capacity group level of the local host node. In this example, each node can receive multimedia data from other nodes of a spare capacity group with the same or higher spare capacity group level.

The distributed resource manager 360 may also terminate forwarding to or receiving information from another node or group. In one example, the distributed resource manager 360 can unsubscribe from a spare capacity group. In another example, the distributed resource manager 360 can send one or more commands to another node refusing multimedia information or routing information.

The distributed resource manager 360 of a first node is not limited to forming spare capacity groups. The distributed resource manager 360 may form any kind of group for forwarding or receiving information. Similarly, the distributed resource manager 360 may forward or receiving information from multiple groups.

The distributed resource manager 360 may also request additional resources or multimedia data from one or more nodes based on the performance of the host node. In an example, the distributed resource manager 360 subscribes to a spare capacity group. Subsequently, the quality manager 330 indicates that the quality of the performance of the host node is below average. The distributed resource manager 360 may request routing information or multimedia data from the spare capacity group by sending a message requesting services to one or more nodes of the spare capacity group. The distributed resource manager 360 of the one or more nodes of the spare capacity group can receive the message requesting routing information or multimedia data and respond by indicating that the receiving node will offer or deny routing information or multimedia data. Alternately, the distributed resource manager 360 of the one or more nodes of the spare capacity group can accept multimedia data requests from other nodes. The distributed resource manager 360 can notify the topology manager 340 that multimedia data request have been received. The topology manager 340 can command the multimedia transmission 350 to begin sending multimedia data to the requesting node, or refuse the multimedia data request.

The topology manager 340 may also be configured to generate and receive leave requests, adoption requests, adoption acceptance acknowledgments, and redirection requests. In some embodiments, the distributed resource manager 360 of a host node receives the adoption request generated by a topology manager 340 of a requesting node. The distributed resource manager 360 of the host node may then notify the topology manager 340 that the adoption request has been received. The topology manager 340 can determine if the requesting node will be adopted. The process of adopting a node is discussed further herein.

In some embodiments, the distributed resource manager 360 is contained within the topology manager 340. In other embodiments, the distributed resource manager 360 may be contained within a separate digital device on the network 100 (FIG. 1). In one example, one or more distributed resource managers 360 are contained within a separate node on the network 100. The one or more distributed resource managers 360 monitor, coordinate, and control shared resources of a multicast group.

The network interface 370 can comprise an interface to communicate with an overlay network. Further, the network interface 370 may comprise a library of routing commands for communicating routing commands with nodes over the overlay network. For example, routing commands may be received by the network interface 370 from other nodes on the overlay network. The network interface 370 translates the routing commands and sends the routing commands to the topology manager 340 and/or the distributed resource manager 360 as routing information. The topology manager 340 and/or the distributed resource manager 360 may evaluate the routing commands and determine a routing characteristic based on the routing information. In another example, the topology manager 340 may send routing commands to the network interface 370. The network interface 370 then translates the routing commands using the library of routing commands to transmit the routing commands to other nodes on the overlay network.

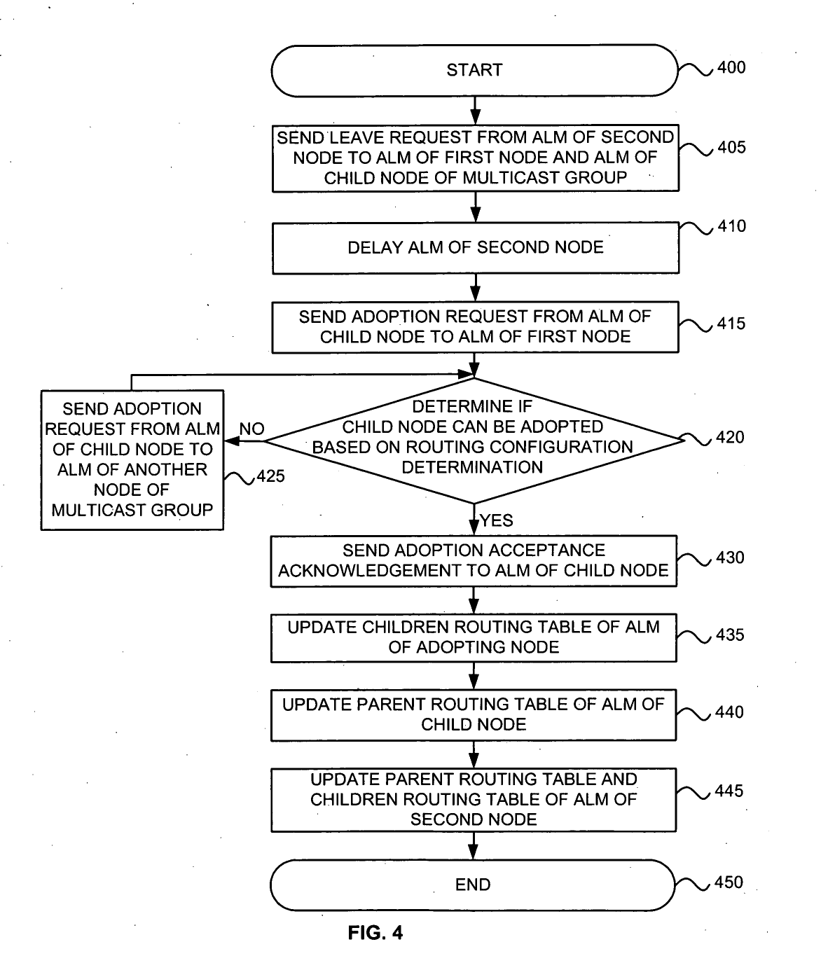

FIG. 4 is a flowchart depicting a method for the application level multicast module 300 as may be used for a node leaving a multicast group, in accordance with one embodiment. In step 400, the application level multicast module 300 (ALM) of a leaving node sends a leave request to an application level multicast module 300 of a parent node and an application level multicast module 300 of a child node. The child node is a child of the leaving node within the multicast group. A leave request is a command indicating that the sending node will no longer be receiving or forwarding multimedia data within a multicast group.

In one example, the leaving node receives multimedia data from the parent node and forwards multimedia data to the child node. The application level multicast module 300 of the leaving node can send the leave request to the application level multicast module 300 of the parent node indicating that the leaving node will no longer be receiving multimedia data. Concurrently, or soon thereafter, the application level multicast module 300 of the leaving node also sends the leave request to the application level multicast module 300 of the child node indicating that the leaving node will no longer be forwarding multimedia data to the child node. In some embodiments, the leave request also indicates that the sending node will no longer be a member of either the multicast group and/or a spare capacity group.

In step 410, the application level multicast module 300 of the leaving node delays the leaving node for a predetermined period of time. In one embodiment, the delay allows the child node time to find a new parent server or parent server/child client and begin receiving multimedia data from the new source without deterioration of service. In other embodiments, the application level multicast module 300 of the leaving node does not delay the leaving node.

In step 420, the application level multicast 300 of the child node sends an adoption request to the application level multicast module 300 of the parent node. An adoption request is a command requesting multimedia data. In some embodiments, the adoption request also indicates that the child node requests membership within the multicast group and/or the spare capacity group. In another example, the application level multicast module 300 of the child node may send the adoption request to any member of the multicast group.

Alternately, the application level multicast module 300 of the leaving node can send a redirection request to the application level multicast module 300 of the parent node. A redirection request is a command requesting that multimedia data be sent from the receiving node to one or more child nodes of the sending node. In one example, the application level multicast module 300 of the leaving node may send a redirection request to the application level multicast module 300 of the parent node requesting that the parent node adopt the child node of the leaving node.

In step 430, the application level multicast module 300 of the parent node determines if the child node of the leaving node can be adopted based on a routing configuration determination. In some embodiments, the topology manager 340 or a combination of the distributed resource manager 360 and the topology manager 340 makes the determination of whether the child node can be adopted.

In one example, the distributed resource manager 360 receives the adoption request from the child node of the leaving node. The distributed resource manager 360 then requests that the topology manager 340 review the host resource information, the shared resources, and the multimedia metric limit to determine if the parent node can send multimedia data to the child node without significant loss of performance. If the topology manager 340 determines to adopt the child node, then the topology manager 340 may send a control signal (via network interface 370) to the node requesting adoption to indicate that the child node is adopted. The topology manager 340 can also send a recommendation to the distributed resource manager 360 to stop forwarding the adoption request to a spare capacity group. Alternately, if topology manager 340 determines to reject the adoption of the child node, then the distributed resource manager 320 can forward the adoption request to another distributed resource manager 360 within another node.

In some embodiments, the topology manager 340 receives an adoption request via the network interface 370, performs the evaluation, and generates a control signal to the child node. In other embodiments, the distributed resource manager 360 receives and forwards the adoption request to the topology manager 340. If the parent node does not adopt the child node, the application level multicast module 300 of the child node executes step 440. If the parent node adopts the child node, the application level multicast module 300 of the parent node executes step 450.

In step 440, the application level multicast module 300 of the child node sends an adoption request to the application level multicast module 300 of another node of the multicast group. FIG. 4 then returns to step 430 where the application level multicast module 300 of the receiving node determines if the child node can be adopted based on a routing configuration determination.

For example, the application level multicast module 300 of the child node sends the adoption request to the application level multicast module 300 of the parent node. The application level multicast module 300 of the parent node receives the adoption request, but does not adopt the child node. The application level multicast module 300 of the child node waits a predetermined period of time to allow for reception of an adoption acceptance acknowledgement indicating adoption. If the adoption acceptance acknowledgement is not received, the application level multicast module 300 of the child node can resend the adoption request to the application level multicast module 300 of the parent node or another node of the multicast group.

In step 450, the application level multicast module 300 of the adopting node sends an adoption acceptance acknowledgement to the application level multicast module 300 of the child node. An adoption acceptance acknowledgement is a command that indicates that a node has been or will be adopted into the multicast group and the parent node will begin to forward multimedia data to the child node. In another embodiment, the application level multicast module 300 of the parent node does not send an adoption acceptance acknowledgement to the application level multicast module 300 of the child node and instead only sends a control signal to the application level multicast module 300 of the child node when the child node is not adopted.

In step 460, the application level multicast module 300 of the adopting node updates the children routing table of the adopting node. In one example, the application level multicast module 300 of the adopting node adds data that indicates that the child node is receiving multimedia data from the adopting node.

In step 470, the application level multicast module 300 of the child node updates the parent routing table of the child node. In one example, the application level multicast module 300 of the child node adds data that indicates that the parent node is receiving multimedia data from the adopting node.

In step 480, the application level multicast module 300 of the leaving node updates the parent routing table and the children routing table of the leaving node. In one example, the leaving node removes data from the parent routing table to indicate that the leaving node is no longer receiving multimedia data from the parent routing table. In another example, the application level multicast module 300 of the leaving node removes data from the children routing table to indicate that the leaving node is no longer sending multimedia data to the child node.

In another embodiment, the topology manager 340 directs the multimedia transmission router 350 to stop sending multimedia data to the child node and to stop receiving multimedia data from the parent node. In other embodiments, the quality manager 330 notifies the topology manager 340 that the leaving node is no longer receiving or forwarding multimedia data.

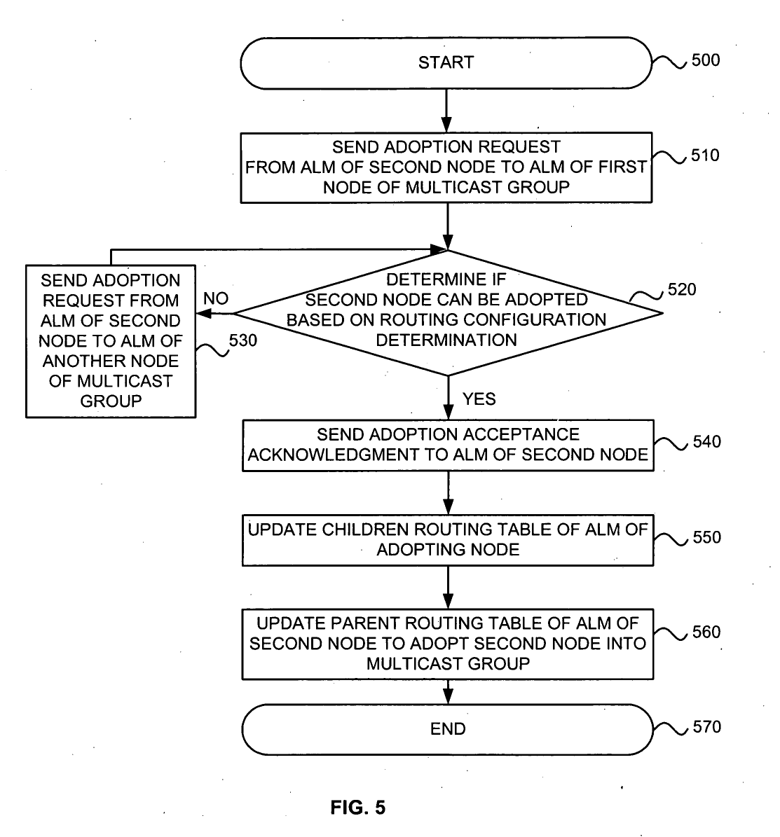

FIG. 5 is a flowchart depicting a method for an application level multicast module 300 as may be used for a node joining a multicast group, in accordance with one embodiment. In step 500, the application level multicast module 300 of a requesting node sends an adoption request to an application level multicast module 300 of a parent node of the multicast group.

In step 510, an application level multicast module 300 of the parent node determines if the requesting node can be adopted based on a routing configuration determination. If the application level multicast module 300 of the parent node determines that the requesting node will be adopted, the application level multicast module 300 of the parent node continues to step 530. If the application level multicast module 300 of the parent node determines that the requesting node will not be adopted, the application level multicast module 300 of the requesting node proceeds to execute step 520.

In step 520, the application level multicast module 300 of the requesting node sends an adoption request to an application level multicast module 300 of an other node of the multicast group. The application level multicast module 300 of the receiving node then returns to step 510.

In step 530, the application level multicast module 300 of the parent node sends an adoption acceptance message to the application level multicast module 300 of the requesting node. In step 540, the application level multicast module 300 of the adopting node updates a children routing table to indicate that the requesting node has been adopted. In step 550, the application level multicast module 300 of the requesting node updates a parent routing table of the requesting node to adopt the requesting node into the multicast group.

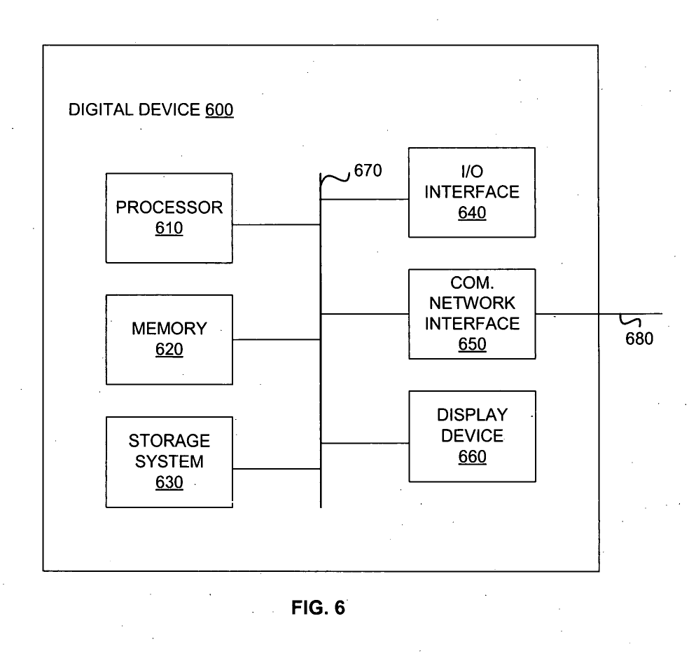

FIG. 6 illustrates a block diagram of a digital device 600 that may implement the application level multicast module, in accordance with one embodiment. The digital device 600 is any device that may implement either hardware, software, or both. Examples of digital devices 600 include, but are not limited to, computers, servers, terminals, personal digital assistants, cell phones, laptops, computing tablets, and personal media devices. The digital device may be a node on the network 100 including the administrative server 110, the broadcaster 115, the parent server/child client 120, the parent server/child client 145, the parent server 130, the child client 125, the child client 135, the child client 140, or the child client 150.

The digital device 600 includes a system bus 670 coupled to a processor 610, a memory 620, a storage system 630, an input/output (I/O) interface 640, a communications (com.) network interface 650, and a display device 660. The communications network interface 650 is further coupled to an external communications link 680.

The processor 610 is configured to execute software or instructions. The memory 620 is any memory device configured to hold data, either permanently or temporarily, to make the data available to any components connected to the system bus 670. The memory 620 may be configured to hold the application level multicast module.

The storage system 630 is any storage device or group of storage devices configured to store data permanently or temporarily. The storage system 630 may be configured to store the application level multicast module.

The I/O interface 640 is any interface or device configured to provide input or output to a user of the digital device 600. For example, the I/O interface 640 may include a video interface, a remote control, a keypad, joystick, touch-screen, or buttons.

The communications network interface 650 is any communication interface configured to transfer data between any components connected to the system bus 670 and any communications network over the external communications link 680. The display device 660 is any device configured to visually interact with the user of the digital device 600. For example, the display device 660 may be a television screen, a monitor, a display for a cell phone, a display for a personal digital assistant, or a terminal display.

The above-described functions can be comprised of instructions that are stored on a computer readable storage medium. The instructions can be retrieved and executed by a processor. Some examples of instructions are software, program code, computer readable code, and firmware. Some examples of computer readable storage medium are storage systems 630, memory 620, memory devices, tape, disks, integrated circuits, and/or servers. The instructions are operational when executed by the processor to direct the processor to operate in accord with the invention. Those skilled in the art are familiar with instructions, processor(s), and storage medium.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a network interface configured to send routing information to and receive other routing information from a first node on a network;
a distributed resource manager configured to send a routing message to and receive an other routing message from a second node on the network;
a multimedia transmission router configured to send multimedia data to and receive multimedia data from a third node on the network;
a transmission control layer module configured to process the multimedia data received from the multimedia transmission router and to ascertain a multimedia transmission quality metric;
a host node manager configured to store host node information and to monitor host resource information;
a quality manager configured to determine a multimedia metric limit based on the multimedia transmission quality metric received from the transmission control layer module; and
a topology manager configured to determine a routing configuration and generate a routing control signal based on the routing configuration determination.

2. The system of claim 1 wherein the first node comprises the third node.

3. The system of claim 1 wherein the first node comprises the second node.

4. The system of claim 1 wherein the routing message comprises an adoption request, an adoption acceptance acknowledgment, a leave request, and/or a redirection message.

5. The system of claim 1 wherein the topology manager is further configured to update a parent routing table.

6. The system of claim 1 wherein the topology manager is further configured to update a children routing table.

7. The system of claim 1 wherein the routing configuration determination is based on the host resource information received from the host node manager.

8. The system of claim 1 wherein the routing configuration determination is based on the multimedia metric limit received from the quality manager.

9. The system of claim 1 wherein the routing configuration determination is based on the other routing information received from the network interface.

10. The system of claim 1 wherein the first node on the network comprises a child client, a parent server, a parent server/child client, or an administrative server.

11. The system of claim 1 wherein the transmission control layer module is further configured to send the processed multimedia data to a multimedia player application.

12. A method comprising:
sending a leave request from a second node of a multicast group to a first node and at least one child node of the multicast group;
updating a children routing table of the first node;
updating a parent routing table of the second node and a children routing table of the second node; and
updating a parent routing table of at least one child node of the multicast group.

13. The method of claim 12 further comprising delaying the second node a predetermined period of time after the leave request has been sent but before the children routing table of the first node or the parent routing table of the second node has been updated.

14. The method of claim 12 further comprising:
sending an adoption request from at least one child node to the first node; and
determining if the first node can adopt at least one child node based on a routing configuration determination.

15. The method of claim 12 further comprising:
sending a redirection message from the second node of the multicast group to the first node; and
determining if the first node can adopt at least one child node.

16. The method of claim 15 further comprising;
updating the children routing table of the first node to adopt at least one child node based on the routing configuration determination;
sending an adoption acceptance acknowledgement from the first node to at least one child node; and
updating the parent routing table of at least one child node.

17. The method of claim 16 wherein the routing configuration determination is based on a host resource information, a multimedia metric limit, and/or routing information.

18. The method of claim 17 wherein the routing information comprises a node group identifier, a host node identifier, child node data, parent node data, and/or spare capacity group data.

19. A method comprising:
sending an adoption request from a second node to a first node of a multicast group;
determining if the first node can adopt the second node based on a routing configuration determination;
sending an adoption acceptance message from the first node to the second node;
updating a children routing table of the first node; and
updating a parent routing table of the second node.

20. The method of claim 19 wherein the routing configuration determination is based on a host resource information, a multimedia metric limit, and/or routing information.

21. The method of claim 20 wherein the routing information comprises a node group identifier, a host node identifier, child node data, parent node data, and/or spare capacity group data.

22. A computer readable medium comprising:
computer readable code contained within the computer readable medium, the computer readable code configured to direct a processor to send a leave request from a second node of a multicast group to a first node and at least one child node of the multicast group, update a children routing table of the first node, update a parent routing table of the second node and a children routing table of the second node, and update a parent routing table of at least one child node of the multicast group.

23. The computer readable medium of claim 22 wherein the module is operational when executed by the processor to delay the second node a predetermined period of time after sending the leave request but before updating the parent routing table of the second node and the children routing table of the second node.

24. The computer readable medium of claim 22 wherein the module is operational when executed by the processor to send an adoption request from at least one child node to the first node and determine if the first node can adopt at least one child node based on a routing configuration determination.

25. The computer readable medium of claim 22 wherein the module is operational when executed by the processor to send a redirection message from the second node of the multicast group to the first node and determine if the first node can adopt at least one child node.

26. The computer readable medium of claim 22 wherein the module is operational when executed by the processor to update the children routing table of the first node to adopt at least one child node based on the routing configuration determination, send an adoption acceptance acknowledgement from the first node to at least one child node, and update the parent routing table of at least one child node.

27. The computer readable medium of claim 26 wherein the routing configuration determination is based on a host resource information, a multimedia metric limit, and/or routing information.
